(19) United States
(12) Patent Application Publication
(10) Pub. No.: US 2015/0016121 A1
(43) Pub. Date: Jan. 15, 2015

(54) ILLUMINATION APPARATUS

(71) Applicant: SHARP KABUSHIKI KAISHA, Osaka-shi, Osaka (JP)

(72) Inventors: Fumio Kokubo, Osaka-shi (JP); Hirokazu Suzuki, Osaka-shi (JP)

(73) Assignee: SHARP KABUSHIKI KAISHA, Osaka-shi,Osaka (JP)

(21) Appl. No.: 14/375,043

(22) PCT Filed: May 20, 2013
(86) PCT No.: PCT/JP2013/063936

§ 371 Date: Jul. 28, 2014

(30) Foreign Application Priority Data
May 21, 2012 (JP) 2012-115482

(51) Int. Cl. F21S 8/02; F21K 99/00; F21V 15/01

(52) U.S. Cl. CPC F21S 8/026; F21V 15/011; F21K 9/30; F21Y 2101/02
USPC 362/365

(57) ABSTRACT

An illumination apparatus includes a radiating fin exposed externally on an upper surface of a casing having a light source and a drive unit accommodated therein, and a securing portion to secure the casing to a ceiling surface. The radiating fin includes a ventilation path that is provided in the form of a groove located between a plurality of fin portions extending in a first direction parallel to each other and has opposite ends in the first direction, externally opened. The securing portion allows the radiating fin to be disposed with a distance from the ceiling surface. When the illumination apparatus is installed on the ceiling surface the radiating fin and the ceiling surface form a space having opposite ends in the first direction, each externally opened, and opposite ends in a second direction corresponding to a direction in which the plurality of fin portions are aligned, each externally opened.

### TECHNICAL FIELD

The present invention relates to an illumination apparatus emitting illumination light, and more specifically to an illumination apparatus installed on a ceiling surface.

### BACKGROUND ART

In recent years, an illumination apparatus that includes a light emitting diode (LED) as a light source is prevalently used. Generally, it is important for an illumination apparatus to externally, efficiently radiate the heat generated by the light source. In particular, it is known that when an illumination apparatus including an LED has the LED heated to reach high temperature exceeding a prescribed temperature, the illumination apparatus emits light significantly inefficiently and the LED per se is also degraded, and the illumination apparatus is thus negatively affected in performance and lifetime as a product.

This tendency is notable in a high-output, high-intensity LED included in a large-size illumination apparatus, in particular, and accordingly, it is significantly important to design the illumination apparatus to radiate the LED's heat efficiently. In addition, the large-size illumination apparatus has a drive unit including a drive circuit for driving the light source, and the drive unit also generates unignorablly large heat. Accordingly, designing the illumination apparatus to efficiently radiate the drive unit's heat is also important.

To efficiently radiate heat generated by an LED and a drive unit provided for driving the LED, for example, Japanese Patent Laying-Open No. 2011-154785 (PTD 1) discloses an outdoor illumination apparatus having a radiating fin exposed externally on an external surface of a casing of the outdoor illumination apparatus.

The outdoor illumination apparatus disclosed in this publication is assumed to be used exclusively as a street light, and it has an attachment rod projecting from the casing's peripheral side surface at a prescribed position laterally so that via the attachment rod the casing is supported by a post or the like.

The outdoor illumination apparatus has an LED accommodated in the casing and the outdoor illumination apparatus has a radiating fin positioned immediately above the LED at a portion corresponding to the casing's upper surface such that the radiating fin is externally exposed. The outdoor illumination apparatus is thus configured to allow the heat generated by the LED to be externally, efficiently radiated via the radiating fin.

### CITATION LIST

### Patent Document

PTD 1: Japanese Patent Laying-Open No. 2011-154785

### SUMMARY OF INVENTION

### Technical Problem

An illumination apparatus is not only installed in a manner as disclosed in the above publication but also in such a manner that the illumination apparatus has its casing secured indoor on a ceiling, outdoor under eaves, or to a similar ceiling surface. When an illumination apparatus is installed on a ceiling surface, it will have its casing with an upper surface covered with the ceiling surface, and if the illumination apparatus has a radiating fin exposed on the upper surface of the casing the portion concerned causes heat to stagnate and if no countermeasures are taken against it the illumination apparatus may not be able to radiate heat sufficiently efficiently.

The present invention has been made in view of the above issue, and contemplates an illumination apparatus capable of radiating heat efficiently while it is installed on a ceiling surface.

### Solution to Problem

The present illumination apparatus is installed on a ceiling surface and includes: a light source to emit illumination light downward; a drive unit provided with a drive circuit for driving the light source; a casing having the light source and the drive unit accommodated therein; a radiating fin exposed externally on an upper surface of the casing at a portion overlying the light source to externally radiate heat generated by the light source; and a securing portion for securing the casing to the ceiling surface. The radiating fin includes a plurality of fin portions extending parallel to each other in a first direction orthogonal to a vertical direction, and a ventilation path in a form of a groove located between the plurality of fin portions and having opposite ends in the first direction, externally opened. The drive unit is disposed at a position immediately adjacent to the radiating fin in a second direction in which the plurality of fin portions are aligned. The securing portion allows the casing to be supported by the ceiling surface to allow the radiating fin to be disposed with a distance from the ceiling surface. Furthermore in the above embodiment the present illumination apparatus has the casing and the securing portion configured such that when the illumination apparatus is installed on the ceiling surface the radiating fin and the ceiling surface form a space having opposite ends in the first direction, each at least partially, externally opened, and opposite ends in the second direction, each at least partially, externally opened.

In the present illumination apparatus the securing portion may include an attachment portion attached to the ceiling surface and a coupling portion coupling the attachment portion and the casing together and in that case preferably the coupling portion is erected upward from a portion of the casing that has the drive unit accommodated therein, at opposite end portions located in the first direction, and the attachment portion is disposed at position having a distance from the upper surface of the casing.

In the present illumination apparatus preferably the casing has the drive unit accommodated therein in a portion having an upper surface substantially equal in level to each of the upper ends of the plurality of fin portions.

In the present illumination apparatus preferably the casing has a partition portion to substantially partition a space having the light source accommodated therein and a space having the drive unit accommodated therein.

In the present illumination apparatus the radiating fin may have a base portion in a form of a flat plate having an upper surface with the plurality of fin portions projecting therefrom upward and in that case preferably the base portion configures at least a portion of the upper surface of the casing and the light source is attached to a lower surface of the base portion.

In the present illumination apparatus the drive unit may be paired with another such drive unit and the radiating fin may be located therebetween in the second direction.

In the present illumination apparatus preferably the light source is a light emitting diode.

### Advantageous Effect of Invention

The present invention can thus provide an illumination apparatus capable of radiating heat efficiently while it is installed on a ceiling surface.

### BRIEF DESCRIPTION OF DRAWINGS

FIG. 1 is a perspective view of an illumination apparatus in an embodiment of the present invention.

FIG. 2 is a front view of an illumination apparatus in an embodiment of the present invention.

FIG. 3 is a right side view of an illumination apparatus in an embodiment of the present invention.

FIG. 4 is a bottom view of an illumination apparatus in an embodiment of the present invention.

FIG. 5 is a partially exploded perspective view of an illumination apparatus in an embodiment of the present invention.

FIG. 6 is a lateral cross section showing an internal structure of an illumination apparatus and a manner of installing the illumination apparatus in an embodiment of the present invention.

FIG. 7 is a perspective view of an illumination apparatus in an embodiment of the present invention schematically showing how air flows near the apparatus's casing when the apparatus is in operation.

FIG. 8 is a longitudinal cross section of the illumination apparatus in the embodiment of the present invention schematically showing how air flows near the apparatus's casing when the apparatus is in operation.

FIG. 9 is a lateral cross section of the illumination apparatus in the embodiment of the present invention schematically showing how air flows near the apparatus's casing when the apparatus is in operation.

### DESCRIPTION OF EMBODIMENTS

Hereinafter reference will be made to the drawings to describe the present invention in an embodiment. In the following embodiment, identical or common components are identically denoted and will not be described repeatedly.

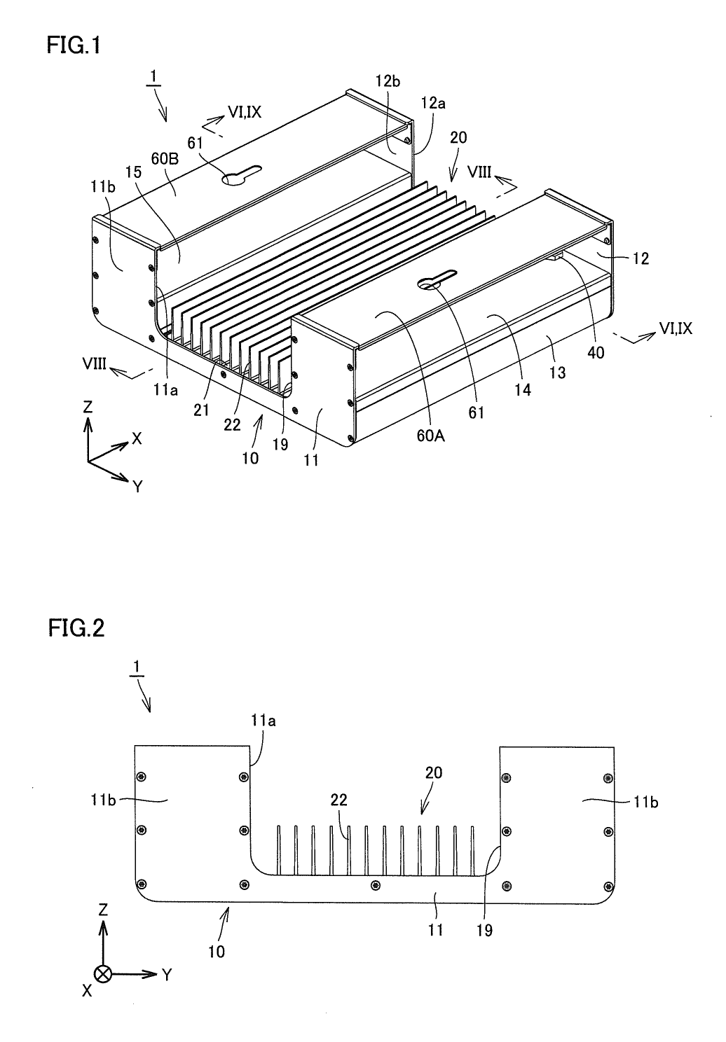

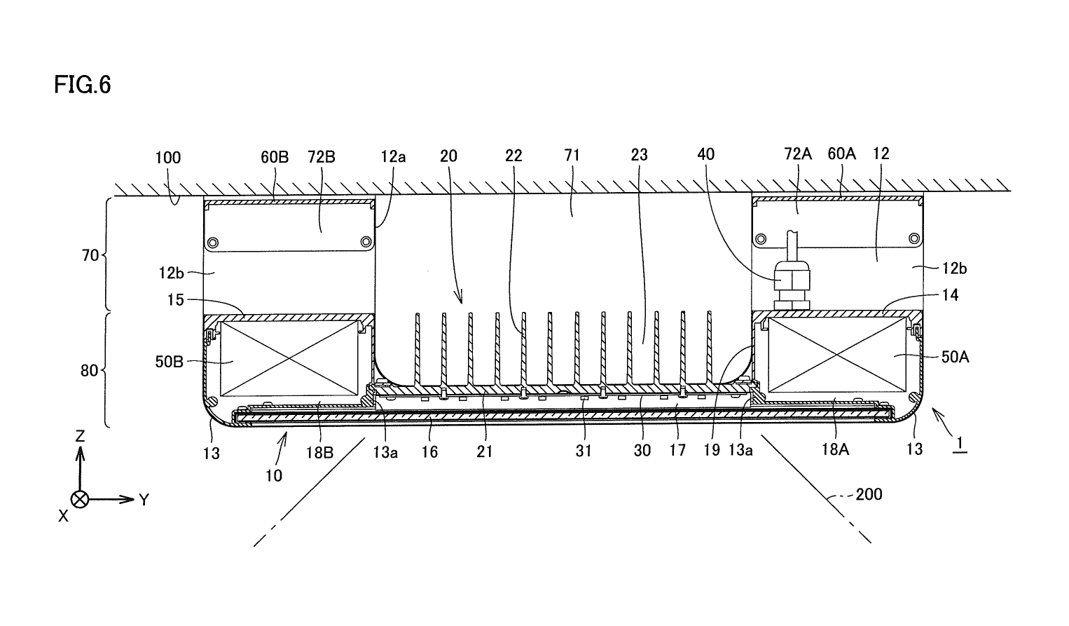

FIG. 1 shows an illumination apparatus in an embodiment of the present invention in a perspective view, and FIGS. 2-4 show the FIG. 1 illumination apparatus in a front view, a right side view, and a bottom view, respectively. FIG. 5 shows the FIG. 1 illumination apparatus in a partially exploded perspective view, and FIG. 6 is a lateral cross section of the FIG. 1 illumination apparatus, as taken along a line VI-VI shown in FIG. 1, to show its internal structure and how it is installed. Initially, reference will be made to FIGS. 1-6 to describe an illumination apparatus 1 in the present embodiment in structure and how it is installed.

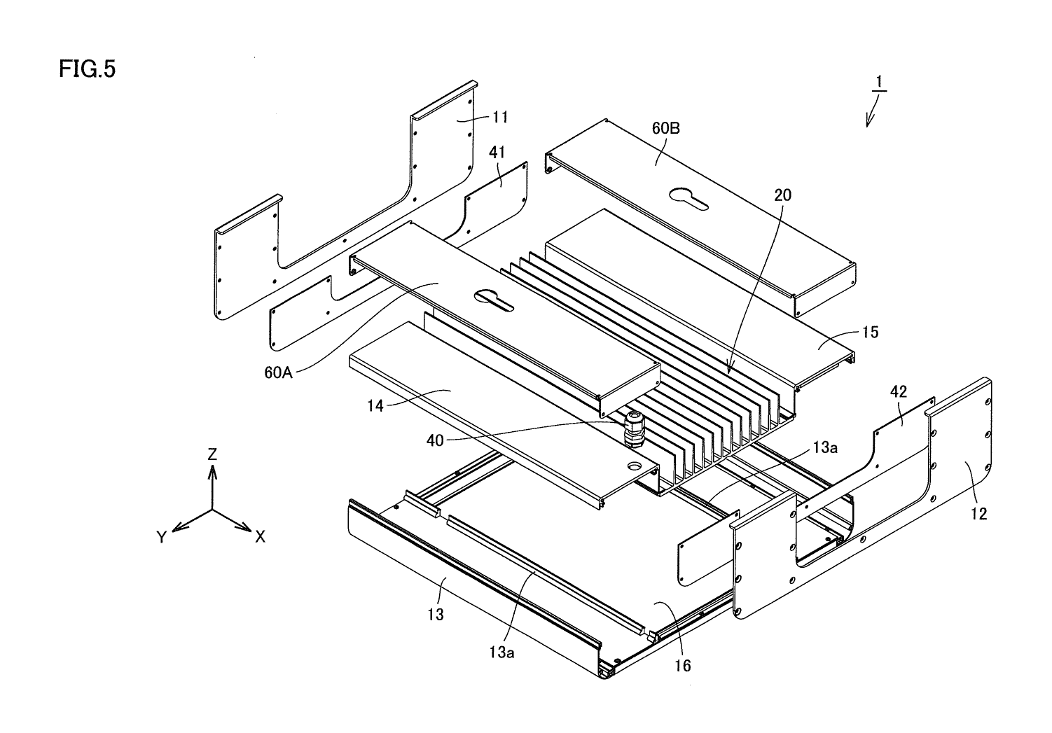

As shown in FIG. 1 to FIG. 6, illumination apparatus 1 includes an LED 31 (see FIG. 4 and FIG. 6 in particular), drive units 50A and 50B (see FIG. 6 in particular), a casing 10, a radiating fin 20, and attachment members 60A and 60B as major components. While illumination apparatus 1, as shown, is generally a rectangular parallelepiped in geometry, illumination apparatus 1 occupies a space generally divided into an upper portion 70 mainly having attachment members 60A and 60B and a lower portion 80 mainly having casing 10 (see FIG. 6 in particular).

Casing 10 is a part that configures a shell of illumination apparatus 1 and internally has a space having a variety of components accommodated therein. The variety of components accommodated in casing 10 mainly include LED 31 and drive units 50A and 50B, which will be described hereinafter more specifically.

Casing 10 is provided in the form of a flat box, and when the illumination apparatus is installed, casing 10 has a front surface and a rear surface orthogonal to an x axis (or a first direction) that matches one of two orthogonal axes in a horizontal plane (i.e., a frontward/rearward direction), a right side surface and a left side surface orthogonal to a y axis (or a second direction) that matches the other of the two orthogonal axes in the horizontal plane (i.e., a rightward/leftward direction), and a upper surface and a lower surface orthogonal to a z axis that matches the vertical direction (i.e., an upward/downward direction).

Casing 10 has on the upper surface a recess 19 extending along the x axis in the form of a groove and reaching the opposite ends of casing 10 that are located in a direction along the x axis. Accordingly, casing 10 will have the upper surface with a step along the z axis, and herein it is assumed that a side surface of recess 19 that configures the step is also included in a portion of the upper surface of casing 10. Casing 10 will thus have in a direction along the y axis a center portion lower in level (or in a direction along the z axis a center portion smaller in length) and opposite side portions higher in level.

More specifically, casing 10 is configured of: a portion of a front cover 11 covering the front surface; a portion of a rear cover 12 covering the rear surface; a lower cover 13 covering the left side surface, the right side surface, and the lower surface partially; a cover lens 16 covering the remainder of the lower surface (see FIG. 4 and FIG. 6 in particular); and an upper right cover 14, an upper left cover 15, and radiating fin 20 covering the upper surface. Note that, in the present embodiment, lower cover 13 is configured of a plurality of members combined together (see FIG. 4 and FIG. 5 in particular), and radiating fin 20 has a base portion 21 (see FIG. 1 and FIG. 6 in particular) also serving as a portion of the upper surface of casing 10.

Casing 10 has its front surface covered with a portion of front cover 11 that corresponds to lower portion 80. Front cover 11 is a member in the form of a flat plate having a U-letter shape in a plan view, and has an upper center portion notched 11a (see FIG. 1 and FIG. 2 in particular). Notched portion 11a is shaped to correspond to recess 19 provided on the upper surface of casing 10 and thus allows recess 19 to have a front end in the direction along the x axis externally opened.

Casing 10 has its rear surface covered with a portion of rear cover 12 that corresponds to lower portion 80. Rear cover 12 is a member in the form of a flat plate having a U-letter shape in a plan view, and has an upper center portion notched 12a (see FIG. 1 and FIG. 6 in particular). Notched portion 12a is shaped to correspond to recess 19 provided on the upper surface of casing 10 and thus allows recess 19 to have a rear end in the direction along the x axis externally opened.

Casing 10 has its right and left side surfaces both covered with lower cover 13. More specifically, lower cover 13 has a pair of side plate portions erected from a portion thereof that covers the lower surface of casing 10, and these side plate portions cover the right and left side surfaces of casing 10.

The lower surface of casing 10 includes an emission surface to emit illumination light downward. The lower surface of casing 10 has a peripheral portion covered with a portion of lower cover 13 other than the side plate portions, i.e., a bottom plate portion, in the form of a frame, and the lower surface of casing 10 has a portion other than the peripheral portion, i.e., a center portion, covered with cover lens 16. Note that cover lens 16 has an exposed surface, which corresponds to the emission surface for emitting illumination light downward as described above.

Of the upper surface of casing 10, the opposite side portions in the direction along the y axis have a portion corresponding to a right side portion thereof, which is covered with upper right cover 14. Upper right cover 14 is a member in the form of a plate having an L-letter shape in cross section and covers an upper surface of the right side portion and a side surface of recess 19 that is located on the right side of recess 19.

Of the upper surface of casing 10, the opposite side portions in the direction along the y axis have a portion corresponding to a left side portion thereof, which is covered with upper left cover 15. Upper left cover 15 is a member in the form of a plate having an L-letter shape in cross section and covers an upper surface of the left side portion and a side surface of recess 19 that is located on the left side of recess 19.

Of the upper surface of casing 10, a center portion in the direction along the y axis has recess 19 with a bottom surface covered with radiating fin 20. Radiating fin 20 serves to externally radiate heat generated by LED 31, and has base portion 21 in the form of a flat plate which is a portion covering the bottom surface of recess 19 provided on an upper surface of casing 10, and a plurality of fin portions 22 projecting upward from an upper surface of base portion 21 (see FIG. 1 and FIG. 6 in particular).

Radiating fin 20 is disposed on an upper surface of casing 10 such that it is externally exposed, and more specifically, the plurality of fin portions 22 are disposed to be located in recess 19 provided on an upper surface of casing 10.

The plurality of fin portions 22 extend along the x axis in parallel and thus provide a plurality of grooves therebetween to serve as a plurality of ventilation paths 23 (see FIG. 6 in particular). The plurality of ventilation paths 23 has opposite ends in the direction along the x axis externally opened.

Radiating fin 20 is a highly thermally conductive member, and suitably, it is a member of metal represented by aluminum or an alloy thereof. Radiating fin 20 may be a die-cast product or may be an extruded product.

Front cover 11, rear cover 12, lower cover 13, upper right cover 14, and upper left cover 15 are each preferably a highly thermally conductive member, suitably a member of metal or resin, more suitably a die-cast or extruded product formed of aluminum or an alloy thereof. Cover lens 16 is an optically transparent member that transmits illumination light, suitably a member of resin or glass.

Of front cover 11, a portion corresponding to upper portion 70 configures a portion of a securing portion for securing casing 10 to ceiling surface 100 (see FIG. 6), and in particular, it configures a coupling portion 11b of the securing portion (see FIG. 1 to FIG. 3 in particular). Coupling portion 11b is erected upward from a portion of front cover 11 that configures the front surface of casing 10, and such coupling portions 11b are provided in a pair to sandwich notch 11a provided at the upper center portion of front cover 11 in the direction along the y axis.

Furthermore, of rear cover 12, a portion corresponding to upper portion 70 configures a portion of the securing portion for securing casing 10 to ceiling surface 100, and in particular, it configures a coupling portion 12b of the securing portion (see FIGS. 1, 3 and 6 in particular). Coupling portion 12b is erected upward from a portion of rear cover 12 that configures the rear surface of casing 10, and such coupling portions 12b are provided in a pair to sandwich notch 12a provided at the upper center portion of rear cover 12 in the direction along the y axis.

More specifically, coupling portion 11b of front cover 11 and coupling portion 12b of rear cover 12 are portions that serve as a spacer for disposing casing 10 with a distance from ceiling surface 100, and are portions that couple attachment members 60A and 60B and casing 10 together. Coupling portions 11b and 12b are provided to casing 10 at four corners and in a vicinity thereof, as seen along the z axis.

More specifically, coupling portions 11b and 12b are erected upward from those portions of casing 10 that correspond to the opposite side portions located in the direction along the y axis, at those opposite end portions, respectively, located in the direction along the x axis. Note that those portions of casing 10 that correspond to the opposite side portions located in the direction along the y axis correspond to those portions of casing 10 having drive units 50A and 50B accommodated therein, as will be described hereinafter. Note that coupling portions 11b and 12b are each configured of a portion of front cover 11 or rear cover 12, as has been set forth above, and accordingly, they are each in the form of a flat plate, and disposed to have a thickness direction to match the x axis and thus continuously disposed to be flush with the front and rear surfaces of casing 10.

Attachment members 60A and 60B configure a portion of the securing portion for securing casing 10 to ceiling surface 100, and configure an attachment portion of the securing portion that is attached to ceiling surface 100, in particular. Attachment members 60A and 60B are each configured of a member in the form of a flat plate extending along the x axis and have a center with an attachment hole 61 for securing to ceiling surface 100 (see FIG. 1 and FIG. 5 in particular).

Attachment member 60A overlies upper right cover 14, and when it is seen along the z axis it is generally equal in size and identical in geometry to the upper surface of upper right cover 14. Furthermore, attachment member 60B overlies upper left cover 15, and when it is seen along the z axis it is generally equal in size and identical in geometry to the upper surface of upper left cover 15.

Attachment members 60A and 60B each have a front end in the direction along the x axis connected to front cover 11 at an upper end of coupling portion 11b, and a rear end in the direction along the x axis connected to rear cover 12 at an upper end of coupling portion 12b.

Note that the paired attachment members may not be provided to extend along the x axis, as described above. For example, one attachment member may connect the upper ends respectively of coupling portions 11a and 11b located at the opposite ends of front cover 11 located in the direction along the y axis and one attachment member may thus extend along the y axis, and the other attachment member may connect the upper ends respectively of coupling portions 12a and 12b located at the opposite ends of rear cover 12 located in the direction along the y axis and the other attachment member may thus extend along the y axis.

Furthermore, the attachment members may be replaced with a single attachment member. In that case, coupling portions 11a and 11b will have their respective upper ends connected to that single attachment member. Furthermore, the attachment member may be divided into four members depending on the number of coupling portions 11a and 11b. In that case, the attachment members will be connected to coupling portions 11a and 11b at their respective upper ends, respectively.

Thus, upper portion 70 is provided with a securing portion formed of coupling portions 11b and 12b and attachment members 60A and 60B, and the securing member has attachment members 60A and 60B secured to ceiling surface 100 via a metal fitting (not shown) through attachment hole 61 to install illumination apparatus 1 on ceiling surface 100 (see FIG. 6).

Casing 10 and the securing portion are configured of front cover 11, rear cover 12, lower cover 13, upper right cover 14, upper left cover 15, radiating fin 20, and attachment members 60A and 60B, which are screwed together integrally. Casing 10 is required to have an internal space configured to be externally watertight, and accordingly, these members are gasketted or the like therebetween at an appropriate location, as required, and thus sealed.

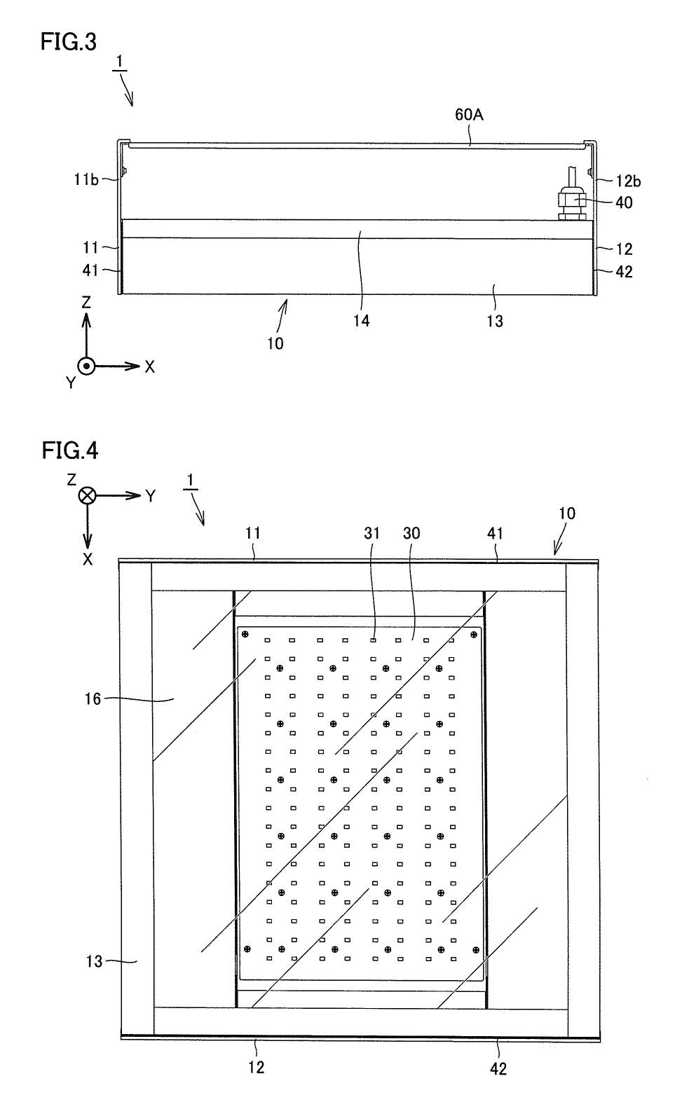

As one example, as shown in FIG. 3 to FIG. 5, between front cover 11 and each of lower cover 13, upper right cover 14 and upper left cover 15, there is provided a front gasket 41 substantially identical in geometry and equal in size to the portion that is gasketted thereby, and between rear cover 12 and each of lower cover 13, upper right cover 14 and upper left cover 15, there is provided a rear gasket 42 substantially identical in geometry and equal in size to the portion that is gasketted thereby.

This allows casing 10 to have its internal space sealed to be externally watertight and can thus prevent moisture represented by humidity, rain water and the like from entering casing 10 and thus allows the illumination apparatus to be installed outdoor.

As shown in FIG. 6, the space internal to casing 10 includes three spaces, i.e., a space immediately under radiating fin 20, a space immediately under the upper surface of upper right cover 14, and a space immediately under the upper surface of upper left cover 15.

Of these spaces, the space immediately under radiating fin 20 corresponds to the portion of casing 10 lower in level as has been set forth above, and this space corresponds to a light source unit accommodation compartment 17 having accommodated therein a light source unit including LED 31. The space immediately under the upper surface of upper right cover 14 and the space immediately under the upper surface of upper left cover 15 correspond to the portion of casing 10 higher in level as has been set forth above, and correspond to drive unit accommodation compartments 18A and 18B having accommodated therein drive units 50A and 50B provided with a drive circuit for driving LED 31.

As shown in FIG. 4 and FIG. 6, the light source unit includes a plurality of LEDs 31 serving as a light source and an LED populated board 30 populated with the plurality of LEDs 31. LED populated board 30 is for example a printed-circuit board formed generally in a rectangle in a plan view to match casing 10 in geometry, and is secured to a lower surface of base portion 21 of radiating fin 20 with a screw or the like. Note that the plurality of LEDs 31 is mounted on a lower surface of LED populated board 30 (i.e., a major surface thereof that faces away from radiating fin 20).

Herein, in the present embodiment, the screw is attached to base portion 21 at a portion corresponding to that provided with fin portion 22. This allows LED populated board 30 to be assembled to radiating fin 20 firmly even if radiating fin 20 has base portion 21 reduced in thickness for enhanced radiation and reduced weight.

Between LED populated board 30 and the radiating fin 20 base portion 21 is inserted a highly thermally conductive sheet, grease and/or the like (not shown). This allows heat generated by LED 31 to be efficiently transferred to radiating fin 20 and can thus prevent LED 31 from reaching high temperature exceeding a prescribed temperature.

LED 31 is a high-intensity LED of low power consumption and long lifetime. LED 31 is mounted on the lower surface of LED populated board 30 for example in an array, a staggered layout or the like. Note that LED 31 is suitably a white light emitting diode.

As shown in FIG. 6, LED populated board 30 has the lower surface opposite to cover lens 16. Cover lens 16 includes a lens appropriately narrowing or diffusing light emitted from the plurality of LEDs 31. This allows light emitted from the plurality of LEDs 31 to be emitted via cover lens 16 downward radially to serve as illumination light 200.

Drive units 50A and 50B include a drive circuit for driving the plurality of LEDs 31, as has been described above, and the drive circuit for example includes a converter circuit to convert AC power to DC power, a buckboost circuit to buckboost voltage, a smoothing circuit to smooth voltage, and a variety of other circuits to receive AC power from an external power supply, such as a commercial power supply, and convert the received AC power to DC power and adjust the DC power to be suitable for driving the plurality of LEDs 31.

Note that drive units 50A and 50B are wired to LED populated board 30 via a harness (not shown) disposed in casing 10, and furthermore, drive units 50A and 50B are electrically connected to each LED 31 via an interconnection pattern provided in LED populated board 30. Furthermore, drive units 50A and 50B are wired via a harness (not shown) that is disposed in casing 10 to a connection terminal 40 provided at a prescribed position on the upper surface of upper right cover 14 of casing 10, and drive units 50A and 50B thus externally receive AC power via connection terminal 40.

Herein, drive units 50A and 50B extend in a direction in which fin portion 22 of radiating fin 20 extends, i.e., along the x axis, and drive units 50A and 50B are disposed in a direction in which fin portions 22 of radiating fin 20 are aligned, i.e., along the y axis, adjacent to radiating fin 20. More specifically, drive units 50A and 50B are secured to a portion that defines the upper surface of upper right cover 14 and a portion that defines the upper surface of upper left cover 15, respectively. In the present embodiment, in particular, drive units 50A and 50B are paired and thus disposed in drive unit accommodation compartments 18A and 18B, respectively, to sandwich radiating fin 20 along the y axis, and radiating fin 20 will thus be located between the paired drive units 50A and 50B along the y axis.

As shown in FIG. 5 and FIG. 6, light source unit accommodation compartment 17 and drive unit accommodation compartments 18A and 18B are substantially partitioned by partition portions 13a erected upward from lower cover 13 of casing 10. Partition portions 13a extend in a direction in which fin portion 22 of radiating fin 20 extends, i.e., along the x axis, and partition portions 13a have upper ends, respectively, abutting against the opposite ends of base portion 21 of radiating fin 20 that are located in the direction along the y axis to partition light source unit accommodation compartment 17 and drive unit accommodation compartments 18A and 18B.

This allows light source unit accommodation compartment 17 and drive unit accommodation compartments 18A and 18B to be close to a thermally independent state, and can reduce mutual interference of heat generated by LED 31 and heat generated by drive units 50A and 50B and thus achieve better heat radiation performance.

While the present embodiment illustrates LED 31 and drive units 50A and 50B accommodated in casing 10 that is a single casing, the casing may be divided and configured so that light source unit accommodation compartment 17 and drive unit accommodation compartments 18A and 18B may be configured in discrete casings' internal spaces, respectively, and the divided casings may be integrated by using a coupler or the like. This can also reduce the aforementioned mutual thermal interference and hence contribute to better heat radiation performance.

Thus in the present embodiment once illumination apparatus 1 has been installed on ceiling surface 100, as shown in FIG. 6, the space occupied by illumination apparatus 1 will have upper portion 70 positionally closer to ceiling surface 100, and lower portion 80 under upper portion 70.

With illumination apparatus 1 thus installed, radiating fin 20 located immediately above light source unit accommodation compartment 17 will be disposed with a distance from ceiling surface 100, and accordingly, a ventilation space 71 will be formed in upper portion 70 between radiating fins 20 and ceiling surface 100.

Furthermore, a ventilation hole 72A will be located in upper portion 70 between upper right cover 14 located immediately above drive unit accommodation compartment 18A and attachment member 60A and a ventilation hole 72B will be located in upper portion 70 between upper left cover 15 located immediately above drive unit accommodation compartment 18B and attachment member 60B, and ventilation holes 72A and 72B communicate with ventilation space 71.

Thus in the present embodiment once illumination apparatus 1 has been installed the space occupied by illumination apparatus 1 will have upper portion 70 with ventilation space 71 having opposite ends in the direction along the x axis, externally opened, and opposite ends in the direction along the y axis, externally opened via ventilation holes 72A and 72B. In other words, ventilation space 71 will have four sides in a horizontal plane, externally opened.

In contrast, as has been set forth previously, the space occupied by illumination apparatus 1 will have lower portion 80 with radiating fin 20 provided with a plurality of grooves serving as ventilation paths 23 in communication with ventilation space 71 along the z axis and also having opposite ends in the direction along the x axis, externally opened. In other words, the plurality of ventilation paths 23 have two sides in a horizontal plane, externally opened.

The present embodiment thus provides illumination apparatus 1 excellent in radiating heat in its installed state. Hereinafter, a ground therefor will be described.

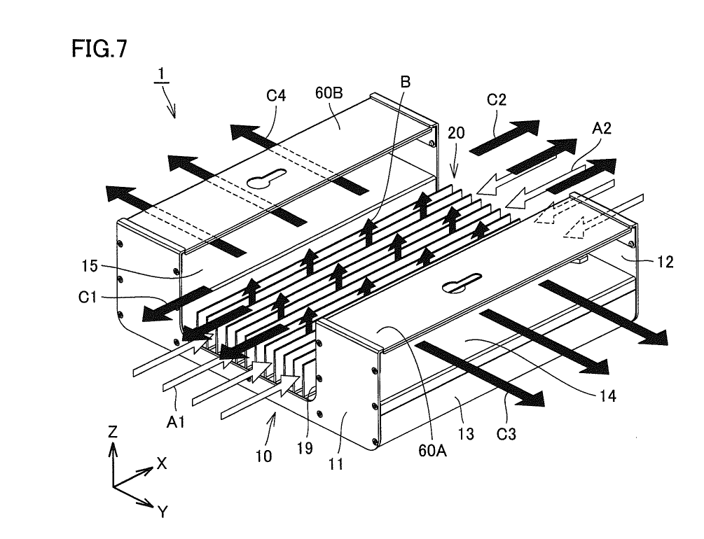

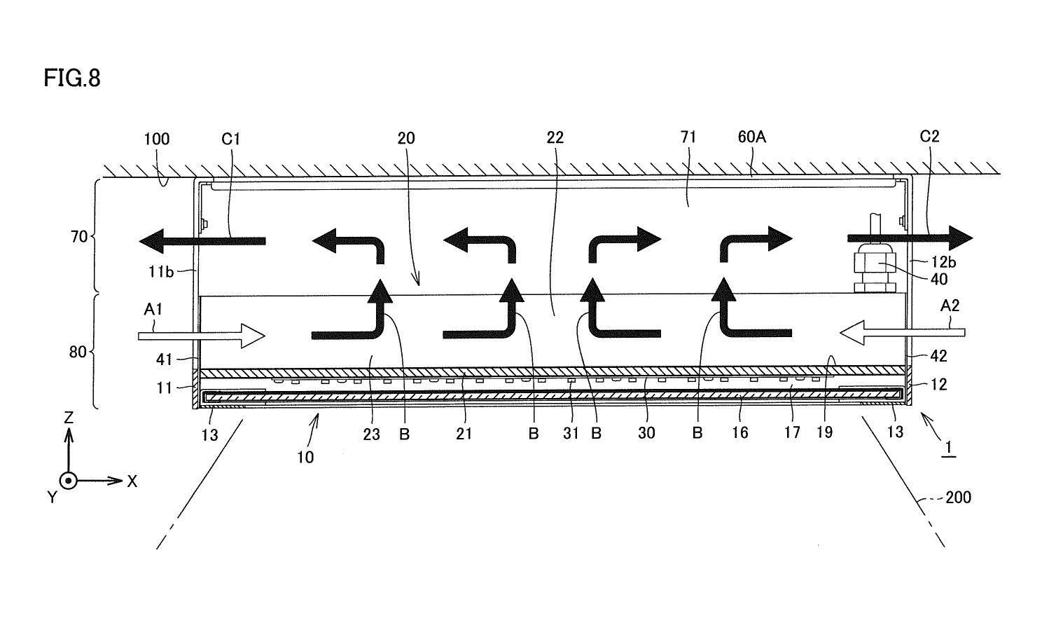

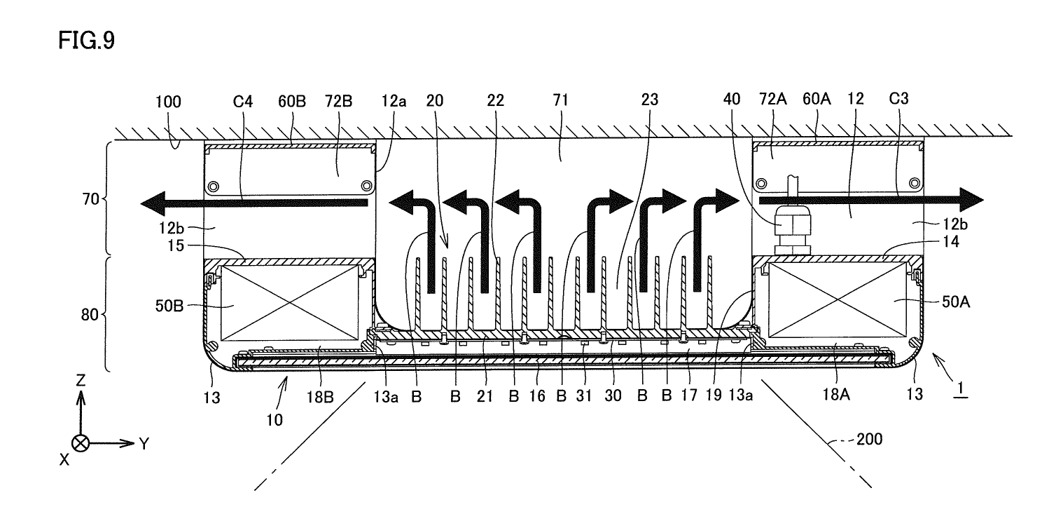

FIG. 7 is a perspective view of the illumination apparatus in the present embodiment to schematically show how air flows near the casing when the illumination apparatus is in operation, and FIG. 8 and FIG. 9 are longitudinal and lateral cross sections taken along lines VIII-VIII and IX-IX, respectively, shown in FIG. 1 to schematically show how the air flows.

As shown in FIG. 7 to FIG. 9, when illumination apparatus 1 is in operation, LED 31 is driven and thus generates heat, which is in turn transferred mainly via LED populated board 30 to base portion 21 of radiating fin 20 and is furthermore transferred to fin portions 22 of radiating fin 20.

The plurality of fin portions 22 receives the heat, which is in turn transferred mainly to air located in ventilation path 23 and thus heats the air. The heated air becomes an upcurrent and moves from ventilation path 23 vertically upward in a direction indicated in the figures by an arrow B, and thus flows into ventilation space 71.

Ventilation space 71 receives the air, which is in turn changed in direction along ceiling surface 100 and thus moves toward the aforementioned four sides and thus egresses. In other words, along the x axis, the heated air moves in directions indicated in the figures by arrows C1 and C2, and along the y axis, the heated air moves in directions indicated in the figures by arrows C3 and C4.

On the other hand, the upcurrent causes a negative pressure in ventilation path 23. This introduces air into ventilation path 23 through its opposite ends. In other words, ventilation path 23 receives air flowing thereinto in directions indicated in the figures along the x axis by arrows A1 and A2.

Thus in the present embodiment illumination apparatus 1 in operation receives air flowing from sideways of radiating fin 20 along arrows A1 and A2 shown in the figures into ventilation path 23, which heats and allows the air to move upward along arrow B indicated in the figures and thus reach ventilation space 71, which in turn allows the air to flow externally along arrows C1, C2, C3, C4 indicated in the figures. This flow of air can efficiently, externally radiate heat generated by LED 31 and thus effectively cool LED 31.

Furthermore, when illumination apparatus 1 is in operation drive units 50A and 50B generate heat, which will mainly be transferred via the upper surface of upper right cover 14 and the upper surface of upper left cover 15 to air flowing through ventilation holes 72A and 72B along arrows C3 and C4 shown in the figures. Accordingly, drive units 50A and 50B will also be cooled effectively.

Note that for enhanced radiation it is preferable that ventilation space 71 provided over radiating fin 20 have an end portion opened over a larger area at its opposite ends located in a direction in which fin portions 22 of radiating fin 20 are aligned, i.e., in the direction along the y axis, than at its opposite ends located in a direction in which fin portions 22 of radiating fin 20 extend, i.e., in the direction along the x axis. This is because, as shown in FIG. 7, along the x axis, the illumination apparatus allows heated air to egress along arrows C1 and C2 whereas the illumination apparatus receives air ingressing along arrows A1 and A2, and ventilation space 71 with its opposite ends in the direction along the x axis opened wider would not allow air to egress in an effectively increased amount, since these flows of air counteract each other resulting in air egressing in a limited amount. Ventilation space 71 that has those opposite ends receiving a relatively small inflow of air, i.e., those located in the direction along the y axis, opened wider, allows air to egress in a more effectively increased amount, and hence contributes to further enhanced radiation.

Thus the present embodiment provides illumination apparatus 1 that allows heat to be radiated via air flowing near casing 10 without interruption and hence smoothly, and if illumination apparatus 1 is installed with radiating fin 20 exposed on the upper surface of casing 10, illumination apparatus 1 can nonetheless efficiently radiate heat. The above configuration can prevent LED 31 from emitting light inefficiently, being degraded, and the like, and allows the illumination apparatus to be excellent in performance and lifetime as a product.

Furthermore, as has been described above, the present embodiment provides illumination apparatus 1 with a securing portion partially configured of coupling portions 11b and 12b erected upward from a portion of casing 10 that has drive units 50A, 50B accommodated therein, at opposite end portions, respectively, located in the direction along the x axis. Ventilation space 71 over radiating fin 20 can have the opposite ends in the direction along the y axis, i.e., those receiving a relatively small inflow of air, uncovered with coupling portions 11b and 12b and thus opened wider. The present embodiment can thus provide illumination apparatus 1 having ventilation space 71 allowing air to egress in an effectively increased amount and can thus ensure large radiation.

Furthermore, the present embodiment provides illumination apparatus 1 such that casing 10 has drive unit 50A, 50B accommodated therein in a portion having an upper surface substantially equal in level to each of the upper ends of the plurality of fin portions 22 of radiating fin 20 along the z axis. This ensures that radiating fin 20 can have the plurality of fin portions 22 in contact with air over a maximally increased area and in addition, also allows ventilation space 71 to laterally pass air to flow without interruption, and large radiation can thus be ensured.

Furthermore, the present embodiment provides illumination apparatus 1 including radiating fin 20 having the plurality of fin portions 22 such that those fin portions located at the opposite ends located in the direction along the y axis are spaced from a pair of side surfaces of recess 19 opposite to the fin portions located at the opposite ends located in the direction along the y axis by a larger distance than the plurality of fin portions 22 are spaced from each other. This can reduce mutual interference of heat generated by LED 31 and heat generated by drive units 50A and 50B and thus provide further enhanced radiation.

A prototype of illumination apparatus 1 of the present embodiment as described above has been produced, and installed on ceiling surface 100 and thus operated to measure what profile in temperature radiating fin 20 has, and it has been confirmed that there is a tendency that while radiating fin 20 in a plan view along the z axis has a center portion highest in temperature and a peripheral portion lower in temperature, radiating fin 20 has the center and peripheral portions with a relatively small, limited difference in temperature therebetween, and furthermore, the peripheral portion has opposite ends in the direction along the x axis and those in the direction along the y axis with a relatively small, limited difference in temperature therebetween.

This suggests that radiating fin 20 entirely, effectively contributes to radiating heat and it has also been confirmed therefrom that illumination apparatus 1 thus configured is excellent in terms of radiation.

While the present invention in the above described embodiment illustrates that a pair of drive units including a drive circuit sandwiches radiating fins, it is not a requirement to provide a pair of drive units, and the drive unit may only be provided at one side depending on the specifications of an output or the like.

Furthermore, while the present invention in the above described embodiment illustrates the securing portion configured of the attachment portion and the coupling portion that are discrete members, they may be provided as a one piece. In other words, the casing and the securing portion for attaching it to a ceiling surface may not be structured as described above, and are variable in geometry, size, configuration and the like, as appropriate.

Furthermore, while the present invention in the above described embodiment illustrates the securing portion configured such that the ventilation space over the radiating fins has opposite ends in a direction in which the radiating fins are aligned, i.e., in the direction along the y axis, each substantially entirely, externally opened, the securing portion may not be so configured, and the ventilation space with the opposite ends in the direction along the y axis each at least partially, externally opened can be expected to provide considerably enhanced radiation.

Furthermore, while the present invention in the above described embodiment illustrates the casing and the securing portion configured such that the ventilation space over the radiating fins has opposite ends in a direction in which the radiating fins extend, i.e., in the direction along the x axis, each entirely, externally opened, the casing and the securing portion may not be so configured, and the ventilation space with the opposite ends in the direction along the y axis each at least partially, externally opened can be expected to provide considerably enhanced radiation.

In addition, while the present invention in the above described embodiment illustrates that the present invention is applied to an illumination apparatus with an LED used as a light source, the present invention is applicable as a matter of course to any illumination apparatus at least including a light source that requires radiating heat.

Thus the embodiment(s) disclosed herein are illustrative and non-restrictive in any respect. The scope of the present invention is defined by the terms of the claims, and is intended to include any modifications within the meaning and scope equivalent to the terms of the claims.

### REFERENCE SIGNS LIST

1: illumination apparatus; 10: casing; 11: front cover; 11a: notch; 11b: coupling portion; 12: rear cover; 12a: notch; 12b: coupling portion; 13: lower cover; 13a: partition portion; 14: upper right cover; 15: upper left cover; 16: cover lens; 17: light source unit accommodation compartment; 18A, 18B: drive unit accommodation compartment; 19: recess; 20: radiating fin; 21: base portion; 22: fin portion; 23: ventilation path; 30: LED populated board; 31: LED; 40: connection terminal; 41: front gasket; 42: rear gasket; 50A, 50B: drive unit; 60A, 60B: attachment member; 61: attachment hole; 70: upper portion; 71: ventilation space; 72A, 72B: ventilation hole; 80: lower portion; 100: ceiling surface; 200: illumination light.

1. An illumination apparatus installed on a ceiling surface, comprising:
a light source to emit illumination light downward;
a drive unit provided with a drive circuit for driving said light source;
a casing having said light source and said drive unit accommodated therein;
a radiating fin exposed externally on an upper surface of said casing at a portion overlying said light source to externally radiate heat generated by said light source; and
a securing portion for securing said casing to the ceiling surface,
said radiating fin including a plurality of fin portions extending parallel to each other in a first direction orthogonal to a vertical direction, and a ventilation path in a form of a groove located between said plurality of fin portions and having opposite ends in said first direction, externally opened,
said drive unit being disposed at a position immediately adjacent to said radiating fin in a second direction in which said plurality of fin portions are aligned,
said securing portion allowing said casing to be supported by the ceiling surface to allow said radiating fin to be disposed with a distance from the ceiling surface,
said casing and said securing portion being configured such that when the illumination apparatus is installed on the ceiling surface said radiating fin and the ceiling surface form a space having opposite ends in said first direction, each at least partially, externally opened, and opposite ends in said second direction, each at least partially, externally opened.

2. The illumination apparatus according to claim 1, wherein:
said securing portion includes an attachment portion attached to the ceiling surface and a coupling portion coupling said attachment portion and said casing together;
said coupling portion is erected upward from a portion of said casing that has said drive unit accommodated therein, at opposite end portions located in said first direction; and
said attachment portion is disposed at position having a distance from said upper surface of said casing.

3. The illumination apparatus according to claim 1, wherein said casing has said drive unit accommodated therein in a portion having an upper surface substantially equal in level to each of upper ends of said plurality of fin portions.

4. The illumination apparatus according to claim 1, wherein said casing has a partition portion to substantially partition a space having said light source accommodated therein and a space having said drive unit accommodated therein.

5. The illumination apparatus according to claim 1, wherein:
said radiating fin has a base portion in a form of a flat plate having an upper surface with said plurality of fin portions projecting therefrom upward;
said base portion configures at least a portion of said upper surface of said casing; and
said light source is attached to a lower surface of said base portion.

6. The illumination apparatus according to claim 1, wherein said drive unit is paired with another said drive unit and said radiating fin is located therebetween in said second direction.

7. The illumination apparatus according claim 1, wherein said light source is a light emitting diode.
